(19) United States
(12) Patent Application Publication
(10) Pub. No.: US 2023/0370776 A1
(43) Pub. Date: Nov. 16, 2023

(54) Audio Signal Distribution Method, Audio Signal Distribution Apparatus, and Audio Signal Distribution System

(71) Applicant: Yamaha Corporation, Hamamatsu-shi (JP)

(72) Inventors: Takanori SHIMIZU, Hamamatsu-shi (JP); Yuki SUEMITSU, Hamamatsu-shi (JP); Koichi SATO, Hamamatsu-shi (JP); Takamichi SATO, Hamamatsu-shi (JP)

(21) Appl. No.: 18/226,845

(22) Filed: Jul. 27, 2023

Related U.S. Application Data
(63) Continuation of application No. PCT/JP2022/004357, filed on Feb. 4, 2022.

(30) Foreign Application Priority Data
Feb. 16, 2021 (JP) 2021-022559

(51) Int. Cl. H04R 3/12

(52) U.S. Cl. CPC H04R 3/12

(57) ABSTRACT

An audio signal distribution method includes assigning in advance a reproduction role to each of a plurality of speakers, distributing an audio signal to the plurality of speakers, according to the reproduction role, and, in response to the number of speakers being decreased, causing a speaker paired with the released speaker on the reproduction role to further reproduce sound of the released speaker.

### CROSS-REFERENCE TO RELATED APPLICATIONS

This application is a continuation of PCT Application No. PCT/JP2022/004357, filed on Feb. 4, 2022, which claims priority to Japanese Application No. 2021-022559, filed on Feb. 16, 2021. The contents of these applications are incorporated herein by reference in their entirety.

### BACKGROUND

### Technical Field

An embodiment of the present disclosure relates to an audio signal distribution method, an audio signal distribution apparatus, and an audio signal distribution system.

### Background Information

U.S. Unexamined Patent Application Publication No. 2017/0251314 discloses a wireless speaker system that distributes audio content to a plurality of speakers, and reproduces the audio content. The wireless speaker system disclosed in U.S. Unexamined Patent Application Publication No. 2017/0251314 includes a party mode in which the audio content is distributed to the plurality of speakers, and an individual mode in which another audio signal is inputted to any one of the plurality of speakers and is individually reproduced.

The number of speakers may be decreased or increased according to a use status of a user. For example, in a case in which an audio signal of stereo L channel and R channel is being reproduced in a living room, a speaker reproducing the audio signal of the L channel may be carried to a bedroom and may be individually used in the bedroom. In such a case, the audio signal of the L channel is not able to be reproduced in the living room.

### SUMMARY

In view of the foregoing, an embodiment of the present disclosure is directed to provide an audio signal distribution method capable of appropriately reproducing an audio signal even in a case in which the number of speakers varies.

An audio signal distribution method according to an embodiment of the present disclosure includes assigning in advance a reproduction role to each of a plurality of speakers, distributing an audio signal to the plurality of speakers, according to the reproduction role, and, in response to the number of speakers being decreased, causing a speaker paired with the released speaker on the reproduction role to further reproduce sound of the released speaker.

According to an embodiment of the present disclosure, even when the number of speakers varies, an audio signal is able to be appropriately reproduced.

### BRIEF DESCRIPTION OF THE DRAWINGS

FIG. 1 is a block diagram showing a configuration of an audio signal distribution system 1.

FIG. 2 is a block diagram showing a configuration of a distribution apparatus 10.

FIG. 3 is a block diagram showing a configuration of a speaker 11.

FIG. 4 is a flow chart showing an operation of the speaker 11 and the distribution apparatus 10 when a mode is changed.

FIG. 5 is an assignment table of a reproduction role of speakers 11 to 14 stored in a flash memory 114 of the distribution apparatus 10.

FIG. 6 is a flow chart showing an operation of the speaker 11 and the distribution apparatus 10 in multi-channel mode.

FIG. 7 is a flow chart showing a change operation of a reproduction channel in the distribution apparatus 10.

FIG. 8 is a block diagram showing a configuration of an audio signal distribution system 1.

FIG. 9 is a block diagram showing a configuration of an audio signal distribution system 1.

FIG. 10 is a block diagram showing a configuration of an audio signal distribution system 1.

FIG. 11 is a block diagram showing a configuration of an audio signal distribution system 1.

FIG. 12 is a block diagram showing a configuration of an audio signal distribution system 1.

FIG. 13 is a block diagram of an audio signal distribution system 1A in a case in which a sound bar 10A is provided as another example of the distribution apparatus.

FIG. 14 is a block diagram showing a configuration of the sound bar 10A.

FIG. 15 is a block diagram showing a configuration of an audio signal distribution system 1B including the speaker 11 and the speaker 12.

FIG. 16 is a block diagram showing a configuration of an audio signal distribution system 1C including a subwoofer 15.

FIG. 17 is a block diagram showing a configuration of a speaker 11 according to Modification 8.

### DETAILED DESCRIPTION

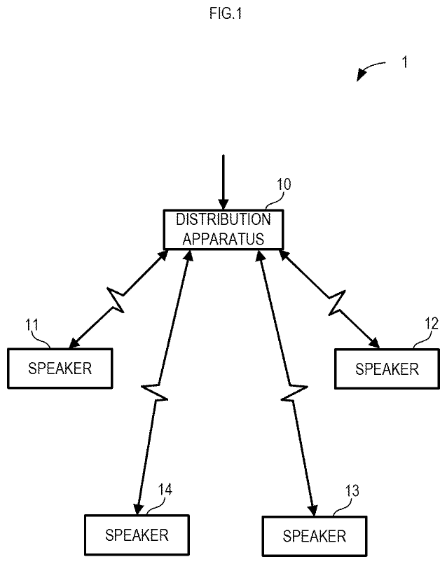

FIG. 1 is a block diagram showing a configuration of an audio signal distribution system 1 according to an embodiment of the present disclosure. The audio signal distribution system 1 includes a distribution apparatus 10 and a plurality of speakers 11 to 14. The distribution apparatus 10 and the plurality of speakers 11 to 14 are connected by wireless communication. However, the distribution apparatus 10 and the plurality of speakers 11 to 14 may be connected by wire such as an audio cable.

The distribution apparatus 10 includes a set top box, a personal computer, an audio receiver, a wireless access point, or a speaker apparatus, for example. The distribution apparatus 10 receives content data from a content reproduction apparatus such as a television or a player. In addition, the distribution apparatus 10 may receive content data from a server or the like, through the Internet.

The distribution apparatus 10 decodes received content data, and extracts an audio signal of a plurality of channels. However, the distribution apparatus 10 may receive a decoded audio signal of the plurality of channels. The distribution apparatus 10 distributes the audio signal of the plurality of channels to the speakers 11 to 14.

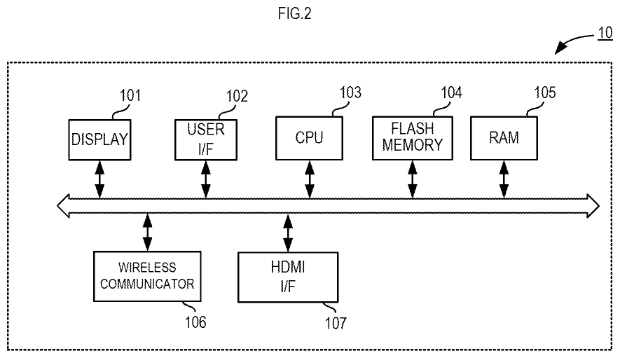

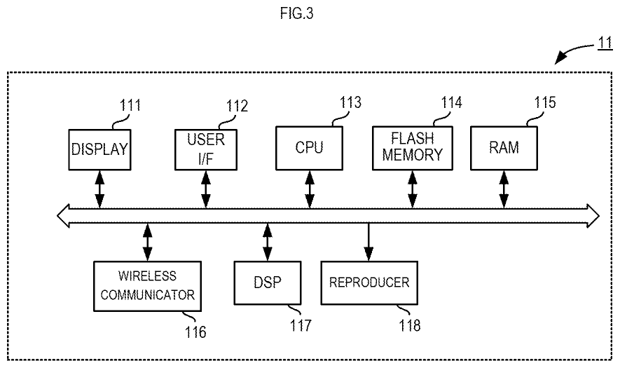

FIG. 2 is a block diagram showing a configuration of the distribution apparatus 10. FIG. 3 is a block diagram showing a configuration of the speaker 11. It is to be noted that, since all the speakers 11 to 14 have the same configuration and function, the configuration of the speaker 11 is shown in FIG. 3 as a representative.

The distribution apparatus 10 includes a display 101, a user interface (I/F) 102, a CPU 103, a flash memory 104, a RAM 105, a wireless communicator 106, and an HDMI (registered trademark) interface (I/F) 107.

The display 101 includes a plurality of LEDs, and displays a standby state/power-on state, for example. The user I/F 102 includes power buttons, for example.

The CPU 103 reads a program stored in the flash memory 104 being a storage medium to the RAM 105 and implements a predetermined function. For example, the CPU 103 decodes the content data received from the HDMI (registered trademark) I/F 107, and extracts the audio signal of the plurality of channels.

The wireless communicator 106 is a wireless communicator that conforms to the standard such as Wi-Fi (registered trademark) or Bluetooth (registered trademark), for example. The wireless communicator 106 communicates with the speakers 11 to 14 by wireless communication such as Wi-Fi (registered trademark) or Bluetooth (registered trademark). The CPU 103 distributes the audio signal of the plurality of channels to the speakers 11 to 14 through the wireless communicator 106.

The speaker 11 includes a display 111, a user interface (I/F) 112, a CPU 113, a flash memory 114, a RAM 115, a wireless communicator 116, a DSP 117, and a reproducer 118.

The display 111 includes a plurality of LEDs, and displays a standby state/power-on state, for example. In addition, the display 111 may display the current reproduction mode. The reproduction mode will be described below.

The user I/F 112 includes power buttons, for example. In addition, the user I/F 112 may include a mode change button that receives a change in reproduction mode.

The CPU 113 reads a program stored in the flash memory 114 being a storage medium to the RAM 115 and implements a predetermined function. For example, the CPU 113 inputs the audio signal received through the wireless communicator 116, to the DSP 117. The DSP 117 performs various types of signal processing to an inputted audio signal. The reproducer 118 includes a not-shown DA converter, an amplifier, and a speaker unit. The reproducer 118 reproduces the audio signal on which the signal processing has been performed by the DSP 117, and emits sound. In addition, the CPU 113 receives the change in reproduction mode through the user I/F 112.

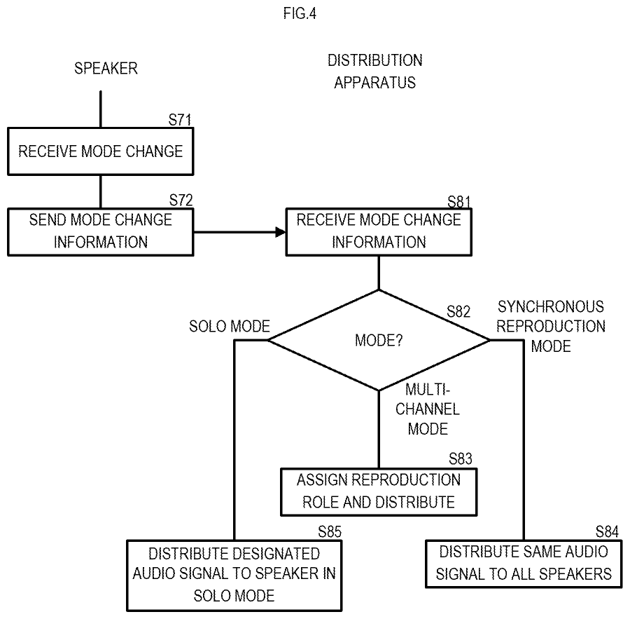

FIG. 4 is a flow chart showing an operation of the speaker 11 and the distribution apparatus 10 when a mode is changed. Although FIG. 4 shows the operation of the speaker 11 as a representative, the other speakers 12 to 14 also perform the same operation.

In addition, the speaker 11 receives the change in reproduction mode through the user I/F 112 (S71). The reproduction mode is set to any of a multi-channel mode, a synchronous reproduction mode, and a solo mode. The speaker 11 sends mode change information according to a received reproduction mode to the distribution apparatus 10 (S72). The distribution apparatus 10 receives the mode change information (S81), and performs an operation according to the received mode change information (S82).

The multi-channel mode is a mode in which an audio signal of a different channel in each of the plurality of speakers is reproduced. The distribution apparatus 10, in a case of receiving a mode change in multi-channel mode, assigns a reproduction role of the speaker that has been set to the multi-channel mode, and distributes an audio signal to the plurality of speakers according to such assignment (S83).

For example, in the example of FIG. 1, the distribution apparatus 10 distributes an audio signal of the L channel to the speaker 11, an audio signal of the R channel to the speaker 12, an audio signal of an SL (a surround L) channel to the speaker 14, and an audio signal of an SR (a surround R) channel to the speaker 13. The speakers 11 to 14 reproduce the audio signal of received from each channel. Accordingly, the audio signal distribution system 1 performs surround reproduction.

The synchronous reproduction mode is a mode in which an audio signal of the same channel of the same content is synchronously reproduced by the plurality of speakers. The distribution apparatus 10, in a case of receiving the mode change information of the synchronous reproduction mode, distributes the same audio signal to all the speakers 11 to 14 connected to each other (S84).

For example, in the example of FIG. 1, the distribution apparatus 10 distributes the audio signal of the L channel and the R channel to the speakers 11 to 14. Each speaker reproduces the audio signal received from the L channel and the R channel. As a result, a user can carry each of the speakers 11 to 14 to a different room, and can listen to the same content as the content that had been being listened to in a certain location (a living room, for example), in a different location (a bedroom, for example).

The solo mode is a mode in which an audio signal of different content from the content of the other speakers is reproduced. In solo mode, the distribution apparatus 10 distributes a designated audio signal to the speaker in solo mode (S85). The speaker receives an audio signal of any content from the distribution apparatus 10. Alternatively, the speaker in solo mode may receive the audio signal of any content, from an existing host apparatus (a server connected through the Internet, for example) other than the distribution apparatus 10, and may reproduce the audio signal.

The user sets at least one of the speakers 11 to 14 as solo mode, and designates content to be reproduced by the speaker that has been set to the solo mode. The user designates the content to be reproduced by the speaker that has been set to the solo mode, by using an information processing apparatus (not shown) such as a smartphone connected to the distribution apparatus 10 and the speakers 11 to 14 through a network.

In addition, the speaker that has been set to the solo mode may connect to a network other than the network in order to connect to the distribution apparatus 10. For example, in a case in which the distribution apparatus 10 connects to the speakers 11 to 14 with Wi-Fi (registered trademark), the speaker that has been set to the solo mode connects to an information processing apparatus such as a smartphone with Bluetooth (registered trademark), and receives an audio signal from the information processing apparatus.

As a result, the user can carry the speaker from the certain location (a living room, for example) to the different location (a bedroom, for example), and can listen to different content from the content that had been being listened to in the living room.

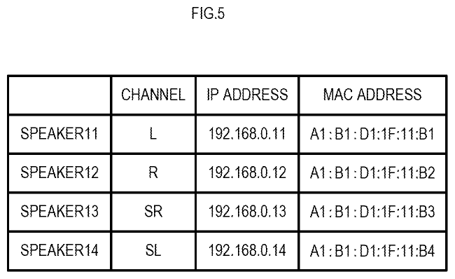

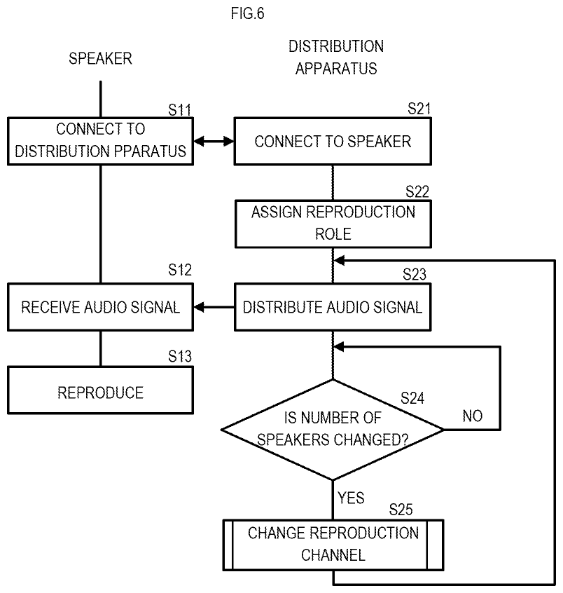

Next, the operation in multi-channel mode will be described with reference to FIG. 5 and FIG. 6. As described above, in multi-channel mode, the distribution apparatus 10 assigns the reproduction role of each of the speakers 11 to 14 in advance, and distributes an audio signal to the speakers 11 to 14 according to such assignment.

FIG. 5 is an assignment table of the reproduction role of the speakers 11 to 14 stored in the flash memory 114 of the distribution apparatus 10. The distribution apparatus 10 assigns the reproduction role to each of the speakers 11 to 14. In the example of FIG. 5, the distribution apparatus 10 assigns the L channel to the speaker 11, the R channel to the speaker 12, the SR channel to the speaker 13, and the SL channel to the speaker 14.

The distribution apparatus 10 identifies the speakers 11 to 14 by use of an IP address and a MAC address. The MAC address is an example of identification information unique to the speaker. The IP address is a local IP address and is added by a not-shown router. It is to be noted that, in a case in which the distribution apparatus 10 has a function of a router, the distribution apparatus 10 adds the IP address. The distribution apparatus 10 stores the IP address, MAC address, and reproduction role of each speaker in association with each other, in the flash memory 114.

It is to be noted that the assignment table of the reproduction role is not limited to the example in which the distribution apparatus 10 stores the assignment table. For example, the speakers 11 to 14 may store the assignment table of the reproduction role. In addition, the assignment table of the reproduction role may be stored in the information processing apparatus that the user owns, such as a smartphone, or a remote controller or the like. The distribution apparatus 10, in a case of referring to the assignment table of the reproduction role, downloads the table each time from the apparatus that stores the table.

FIG. 6 is a flow chart showing an operation of the speaker 11 and the distribution apparatus 10 in multi-channel mode. Although FIG. 6 shows the operation of the speaker 11 as a representative, the other speakers 12 to 14 also perform the same operation.

As shown in FIG. 6, the speaker 11 connects to the distribution apparatus 10 through a network (S11). Similarly, the distribution apparatus 10 connects to the speakers 11 to 14 through a network (S21). The distribution apparatus 10, as shown in FIG. 5, assigns the reproduction role for each connected speaker (S22). A user, for example, operates the distribution apparatus 10 and the speakers 11 to 14, and sets the reproduction role in advance. The user may set the reproduction role by using the information processing apparatus (not shown) such as a smartphone to be connected to the distribution apparatus 10 through the network.

The distribution apparatus 10 distributes an audio signal of the channel assigned to each of the speakers 11 to 14 (S23). The speakers 11 to 14 receive the audio signal of each channel (S12), and reproduce the audio signal (S13).

Then, the distribution apparatus 10 determines whether or not the number of connected speakers is changed (S24), changes the audio signal to be distributed when the number of speakers is changed, and causes the speaker to change the channel of the audio signal to be reproduced by the speaker (S25).

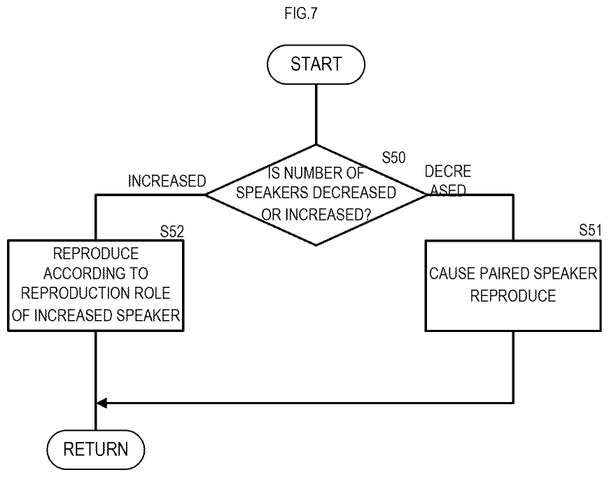

FIG. 7 is a flow chart showing a change operation of a reproduction channel in the distribution apparatus 10. The distribution apparatus 10 determines whether the number of speakers has been increased or decreased (S50). For example, when any of the speakers 11 to 14 is in solo mode, the number of speakers is decreased. Alternatively, also in a case in which any of the speakers 11 to 14 moves farther away and is disconnected from the network, the number of speakers is decreased. In addition, also in a case in which any of the speakers 11 to 14 shifts to the standby state, the number of speakers is decreased. The distribution apparatus 10 is able to determine whether or not the number of connected speakers is changed, by periodically performing a connection check with the speakers 11 to 14, for example. Alternatively, the distribution apparatus 10, in a case of connecting to the speakers 11 to 14 through a not-shown router, is also able to determine whether or not the number of connected speakers is changed, by receiving information (such as a list of IP addresses, for example) on a current connection device, from the router.

The distribution apparatus 10, in a case of determining that the number of speakers has been decreased, performs processing to cause a speaker paired with a decreased speaker on the reproduction role to reproduce the sound of the decreased speaker (S51). The reproduction role pairs the L channel with the R channel, for example. In addition, as with the L channel and the SL channel or the R channel and the SR channel, the front channel and the surround channel are also paired on the reproduction role.

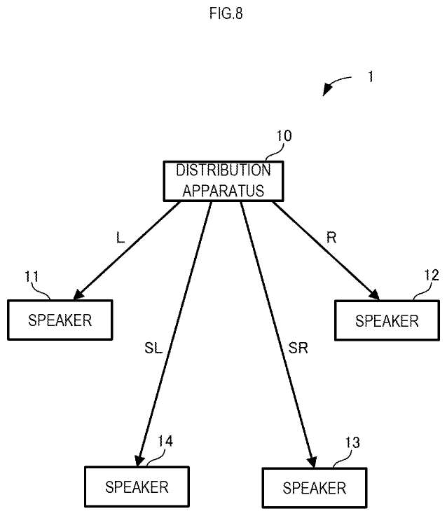

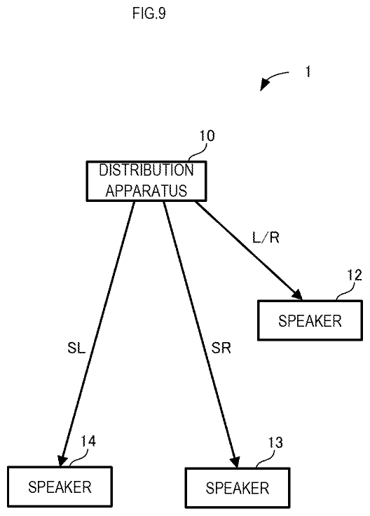

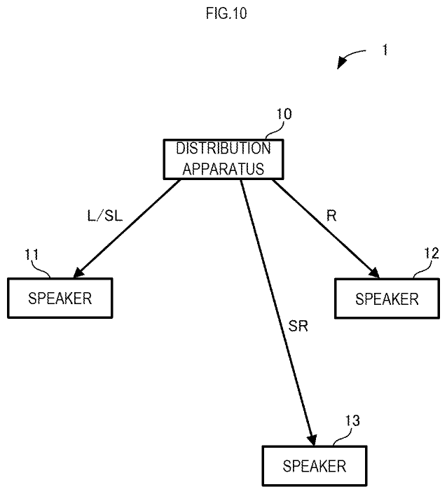

For example, in the example of FIG. 8, the speaker 11 reproduces the L channel, the speaker 12 reproduces the R channel, the speaker 13 reproduces the SR channel, and the speaker 14 reproduces the SL channel. In such a state, in a case in which the connection of the speaker 11 is released as shown in FIG. 9, the distribution apparatus 10 distributes the audio signal of the L channel and the R channel to the speaker 12 paired with the speaker 11 on the reproduction role. The speaker 12 reproduces the audio signal of the L channel and the R channel. In addition, in a case in which the connection of the speaker 14 is released as shown in FIG. 10, the distribution apparatus 10 distributes the audio signal of the L channel and the SL channel to the speaker 11 paired with the speaker 14 on the reproduction role. The speaker 11 reproduces the audio signal of the L channel and the SL channel.

In such a manner, the distribution apparatus 10, in a case in which the number of speakers has been decreased, performs processing to cause a speaker paired with a decreased speaker on the reproduction role to reproduce the sound of the decreased speaker. Therefore, the audio signal distribution system 1, even in the case in which the number of speakers has been decreased, does not lack the channel of the decreased speaker, by reproducing the channel of the decreased speaker by use of a paired speaker on the reproduction role. Therefore, the multi-channel mode that is comfortable for the user is maintainable.

On the other hand, the distribution apparatus 10, in a case of determining that the number of speakers has been increased, performs processing to reproduce sound according to the reproduction role of an increased speaker (S52). The distribution apparatus 10, in a case in which the number of speakers has been increased, distributes the audio signal of the channel assigned to the increased speaker, with reference to the assignment table of the reproduction role. In addition, the distribution apparatus 10 also distributes the audio signal of the channel according to the assignment table of the reproduction role, to a speaker paired with the increased speaker on the reproduction role. For example, in a case in which the state of FIG. 9 shifts to the state of FIG. 8, the distribution apparatus 10 distributes the audio signal of the L channel to the speaker 11. Moreover, the distribution apparatus 10 distributes the audio signal of the R channel to the speaker 12.

In this manner, the audio signal distribution system 1 according to the present embodiment, when changing the mode of the speaker from multi-channel mode to solo mode, causes a paired speaker on the reproduction role to reproduce sound of a plurality of channels. Then, the audio signal distribution system 1, when changing the solo mode of the speaker back to multi-channel mode, distributes an audio signal according to the reproduction role assigned in the past. In addition, the audio signal distribution system 1 according to the present embodiment, when setting the speaker in multi-channel mode to a standby state, causes the paired speaker on the reproduction role to reproduce sound of a plurality of channels. Then, the audio signal distribution system 1, when shifting the standby state of the speaker to the power-on state, distributes an audio signal according to the reproduction role assigned in the past. Alternatively, the audio signal distribution system 1 according to the present embodiment, even when disconnecting a certain speaker from the network by moving the speaker at a distant location, or the like, causes the paired speaker on the reproduction role to reproduce sound of a plurality of channels. Then, the audio signal distribution system 1, when reconnecting the speaker disconnected from the network to the network by moving the speaker to a location near the distribution apparatus 10, or the like, distributes an audio signal according to the reproduction role assigned in the past.

### (Modification 1)

In the above embodiment, the distribution apparatus 10 distributes the audio signal of each channel to paired speakers on the reproduction role. For example, the distribution apparatus 10 distributes the audio signal of the stereo L channel to the speaker 11, and distributes the audio signal of the stereo R channel to the speaker 12.

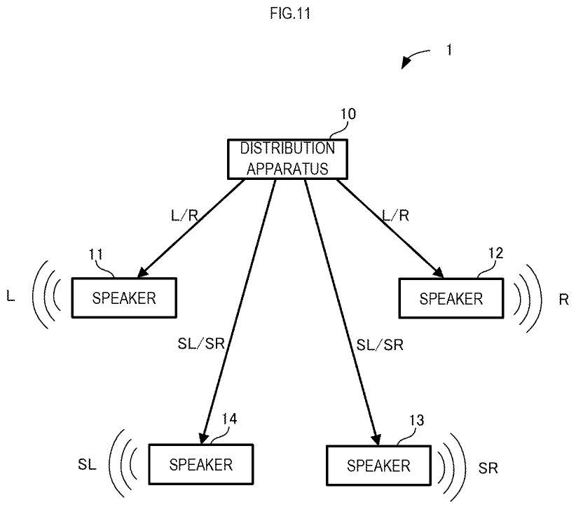

However, the distribution apparatus 10 may distribute both audio signals to each of the paired speakers on the reproduction role. For example, as shown in FIG. 11, the distribution apparatus 10 may distribute the audio signal of both of the stereo L channel and the stereo R channel to the speaker 11, and may also distribute the audio signal of both of the stereo L channel and the stereo R channel to the speaker 12. In addition, the distribution apparatus 10 may distribute the audio signal of both of the surround SL channel and the surround SR channel to the speaker 13, and may also distribute the audio signal of both of the surround SL channel and the surround SR channel to the speaker 14.

In such a case, the distribution apparatus 10 distributes information that shows the reproduction role assigned to each speaker. The speakers 11 to 14 each receive the information and the audio signal of the plurality of channels. The speakers 11 to 14 each reproduce the audio signal of the channel according to the reproduction role assigned to the own apparatus.

For example, the speaker 11, although receiving the audio signal of both of the stereo L channel and the stereo R channel, reproduces the audio signal of the L channel. The speaker 12, although receiving the audio signal of both of the stereo L channel and the stereo R channel, reproduces the audio signal of the R channel. The speaker 13, although receiving the audio signal of both of the surround SL channel and the surround SR channel, reproduces the audio signal of the SR channel. The speaker 14, although receiving the audio signal of both of the surround SL channel and the surround SR channel, reproduces the audio signal of the SL channel.

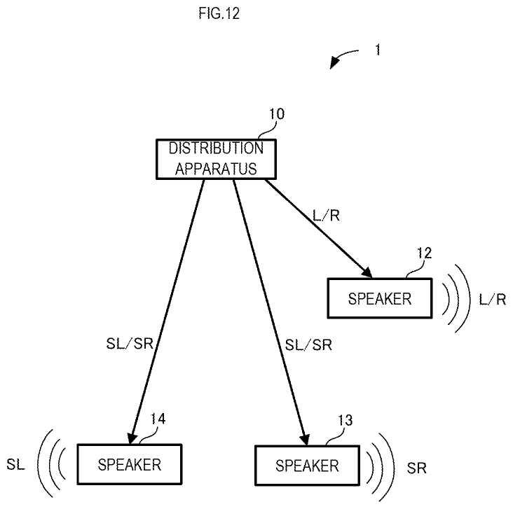

Then, the distribution apparatus 10, in a case in which the number of speakers has been decreased, causes a speaker paired with a decreased speaker on the reproduction role to reproduce both audio signals. For example, when the speaker 11 decreases as shown in FIG. 12, the distribution apparatus 10 perform instructions to reproduce both of the stereo L channel and the stereo R channel, to the speaker 12. The speaker 12 reproduces both of the stereo L channel and the stereo R channel according to the instructions of the distribution apparatus 10.

In addition, the distribution apparatus 10 may distribute the audio signal of all the channels to all the speakers. In such a case as well, the speakers 11 to 14 each reproduce the audio signal of the channel according to the reproduction role assigned to the own apparatus. The distribution apparatus 10, in a case in which the number of speakers has been decreased, causes a speaker paired with a decreased speaker on the reproduction role to reproduce the audio signal of the plurality of channels. For example, in a case in which the connection with the speakers 12 to 14 is released, the distribution apparatus 10 performs the instructions to reproduce the audio signal of all the channels, to the speaker 11. The speaker 11 reproduces the audio signal received from all the channels.

However, as shown in FIG. 8 and FIG. 9, in a case in which the distribution apparatus 10 distributes the audio signal of the channel according to the reproduction role of the speakers 11 to 14, the data amount of the audio signal to be distributed to each speaker is able to be reduced in comparison with the above Modification 1. In particular, wireless communication is a time-division system in which some data is sent while other data is not sent. Therefore, the distribution apparatus 10, while distributing an audio signal to a certain speaker, is unable to distribute an audio signal to other speakers. The speakers 11 to 14 retain an audio signal in a buffer in order to synchronize reproduction timing with the other speakers. As the time to distribute an audio signal to one speaker is increased, the capacity (retainable time) of the buffer needs to be increased. In addition, when the capacity (retainable time) of the buffer is exceeded, reproduction of some audio signals may lack. As shown in FIG. 8 and FIG. 9, in a case in which the distribution apparatus 10 distributes the audio signal of the channel according to the reproduction role of the speakers 11 to 14, the capacity of the buffer is able to be reduced and the reproduction of an audio signal is able to be prevented from lacking.

### (Modification 2)

In the above embodiment, the distribution apparatus 10 determines whether or not the number of connected speakers is changed, by periodically performing the connection check with the speakers 11 to 14. Alternatively, the distribution apparatus 10 determines whether or not the number of connected speakers is changed, by receiving information (such as a list of IP addresses, for example) on the current connection device from a not-shown router. In other words, the distribution apparatus 10 detects an increase or decrease in the number of speakers, based on a connection status of the network. However, the distribution apparatus 10 may detect the increase or decrease in the number of speakers by detecting sound reproduced from the speakers 11 to 14, by a microphone.

For example, the distribution apparatus 10 detects the increase or decrease in the number of speakers, by calculating a correlation value between an audio signal obtained by the microphone and an audio signal of each channel distributed to the speakers 11 to 14. The distribution apparatus 10 calculates the correlation value between the audio signal of the L channel and the audio signal obtained by the microphone, for example. The distribution apparatus 10, in a case in which a calculated correlation value is a predetermined threshold value or more, determines to be connected to the speaker 11. The distribution apparatus 10, in a case in which the calculated correlation value is less than the predetermined threshold value, determines that communication with the speaker 11 has been disconnected, and causes the speaker 12 to reproduce the audio signal of the L channel and the R channel. The distribution apparatus 10 is able to determine whether or not the number of connected speakers is changed, by similarly obtaining the correlation value between the audio signal of each channel and the audio signal obtained by the microphone.

It is to be noted that the speakers 11 to 14 output non-audible (20 kHz or more, for example) sound, and the distribution apparatus 10 may detect the non-audible sound by the microphone, so that the increase or decrease in the number of speakers may be detected. The distribution apparatus 10, in a case of obtaining a test sound at a predetermined level or more, determines that each speaker is connected. The distribution apparatus 10, in a case of being no longer unable to obtain the test sound, determines that communication with each speaker has been disconnected. The non-audible sound may be assigned to a unique frequency band for each speaker. For example, the speaker 11 reproduces the test sound in the frequency range of 20 to 21 kHz, the speaker 12 reproduces the test sound in the frequency range of 21 to 22 kHz, the speaker 13 reproduces the test sound in the frequency range of 22 to 23 kHz, and the speaker 14 reproduces the test sound in the frequency range of 23 to 24 kHz. The distribution apparatus 10, in a case of obtaining the test sound at a predetermined level or more in the frequency range of 20 to 21 kHz, determines to be connected to the speaker 11. The distribution apparatus 10, in a case of being no longer unable to obtain the test sound in the frequency range of 20 to 21 kHz, determines that communication with the speaker 11 has been disconnected. In addition, the non-audible sound may be a spread code (pseudo noise) uniquely assigned to each speaker, for example. In this case, the distribution apparatus 10 obtains a correlation value between the spread code of each speaker and the audio signal obtained by the microphone. The distribution apparatus 10 calculates the correlation value between the spread code of the speaker 11 and the audio signal obtained by the microphone, for example. The distribution apparatus 10, in a case in which a calculated correlation value is a predetermined threshold value or more, determines to be connected to the speaker 11. The distribution apparatus 10, in a case in which the calculated correlation value is less than the predetermined threshold value, determines that communication with the speaker 11 has been disconnected, and causes the speaker 12 to reproduce the audio signal of the L channel and the R channel.

### (Modification 3)

The distribution apparatus 10 may measure a distance to the speakers 11 to 14. The distribution apparatus 10 sends output instructions of a test sound to each of the speakers 11 to 14, for example. The distribution apparatus 10 detects the test sound by the microphone. The distribution apparatus 10 obtains a time difference from sending the output instructions to detecting the test sound by the microphone, as a distance to each of the speakers 11 to 14. Then, the distribution apparatus 10, in a case in which the distance to each speaker is a predetermined threshold value or more, determines that communication with each speaker has been disconnected. In addition, the distribution apparatus 10, in a case in which the distance to each speaker is less than the predetermined threshold value, determines to be connected to each speaker.

It is to be noted that the distribution apparatus 10 may obtain position information of the speakers 11 to 14 by use of a plurality of microphones. The distribution apparatus 10 is able to uniquely obtain the position of the speaker by measuring the distance to the speaker by three microphones placed in a different position.

The distribution apparatus 10 obtains the position information of the speakers 11 to 14, and is able to perform various types of processing based on the position information of each speaker. For example, the distribution apparatus 10 is able to determine to distribute an audio signal of which channel to which speaker at what level, based on the position information of each speaker. As a result, the distribution apparatus 10 is able to perform advanced processing such as processing to localize an acoustic image of a sound source or processing to reproduce an indirect sound to support a sound field of a listening environment, based on the position information of each speaker.

### (Modification 4)

The distribution apparatus 10, in the case in which the number of speakers has been decreased, may increase the volume of a speaker paired with a decreased speaker on the reproduction role. For example, the distribution apparatus 10, in a case of determining that the communication with the speaker 11 has been disconnected, sends instruction information to increase the volume by 6 dB, to the speaker 12. The speaker 12 increases the volume of sound to be reproduced by 6 dB, based on the instruction information. As a result, the audio signal distribution system 1 is able to compensate for a reduction in volume due to the decreased number of speakers.

### (Modification 5)

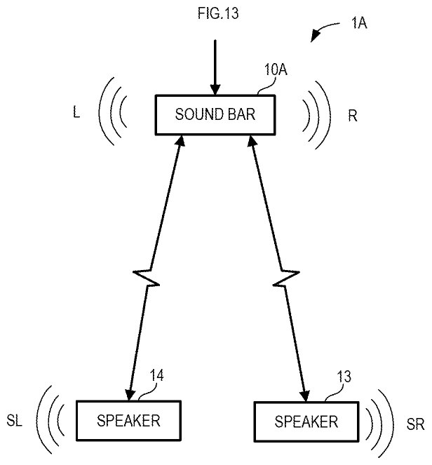

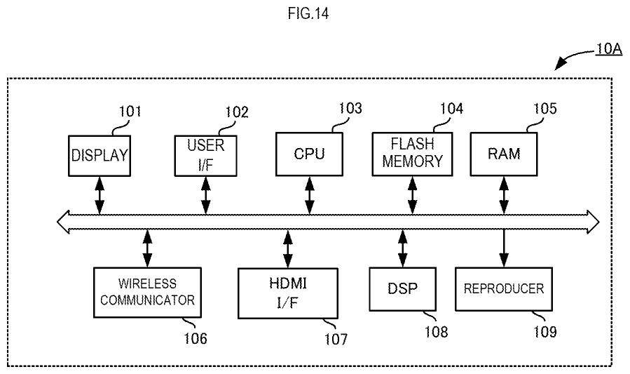

The distribution apparatus 10 may be a speaker, as described above. FIG. 13 is a block diagram of an audio signal distribution system 1A in a case in which a sound bar 10A is provided as another example of the distribution apparatus. FIG. 14 is a block diagram showing a configuration of the sound bar 10A. The audio signal distribution system 1A is different from the audio signal distribution system 1 in that the sound bar 10A is provided in place of the distribution apparatus 10, and other configurations are the same as the configurations of the audio signal distribution system 1.

The sound bar 10A is different from the distribution apparatus 10 shown in FIG. 2 in that a DSP 108 and a reproducer 109 are further provided. The other configurations and functions in the sound bar 10A are the same as the configurations and functions of the distribution apparatus 10. The sound bar 10A is installed on a top surface such as a television stand under the front of a television, for example, and is a wide and low-height speaker.

The CPU 103 decodes the content data received from the HDMI (registered trademark) I/F 107, and extracts the audio signal of the plurality of channels. The CPU 103 inputs an extracted audio signal into the DSP 108. The DSP 108 performs various types of signal processing to an inputted audio signal. The reproducer 109 includes a DA converter, an amplifier, and a speaker unit. The reproducer 109 reproduces the audio signal on which the signal processing has been performed by the DSP 108, and emits sound.

As shown in FIG. 13, the sound bar 10A reproduces the audio signal of the L channel and the R channel by the reproducer 109 of the own apparatus, and emits sound. In addition, the sound bar 10A distributes the audio signal of the SR channel to the speaker 13, and distributes the audio signal of the SL channel to the speaker 14.

The sound bar 10A, as with the distribution apparatus 10, in a case of determining that the number of speakers has been decreased, performs processing to cause a speaker paired with a decreased speaker on the reproduction role to reproduce the sound of the decreased speaker. For example, in a case in which the connection of the speaker 14 is released in the example of FIG. 13, the sound bar 10A causes the speaker 13 paired with the speaker 14 on the reproduction role to reproduce the audio signal of the SL channel and the SR channel. Alternatively, the sound bar 10A may further reproduce the audio signal of the SL channel by setting the own apparatus as a speaker paired with the speaker 14 on the reproduction role.

### (Modification 6)

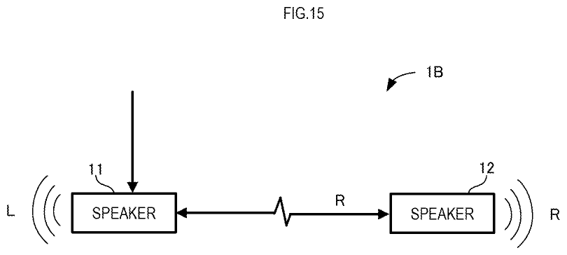

The number of speakers is not limited to the example shown in FIG. 1 and may be two, for example. FIG. 15 is a block diagram showing a configuration of an audio signal distribution system 1B including the speaker 11 and the speaker 12. The audio signal distribution system 1B includes the speaker 11 and the speaker 12. The speaker 11 and the speaker 12 are speakers to be paired with each other on the reproduction role.

The speaker 11 receives the audio signal of the plurality of channels, from the distribution apparatus 10. Alternatively, the speaker 11 receives content data from a content reproduction apparatus such as a player. In addition, the speaker 11 may receive the content data from an information processing apparatus such as a smartphone, a server through the Internet, or the like. The speaker 11, in a case of receiving the content data, decodes the content data and extracts the audio signal of the plurality of channels.

The speaker 11 reproduces the audio signal of the L channel, among received audio signals. In addition, the speaker 11 distributes the audio signal of the R channel to the speaker 12, among the received audio signals. The speaker 12 reproduces the audio signal of the R channel. The speaker 11 may distribute the audio signal of the L channel and the R channel to the speaker 12. The speaker 12 reproduces the audio signal of the R channel, among the received audio signals of the L channel and the R channel.

In this example, the speaker 11 functions as a distribution apparatus that distributes an audio signal to the speaker 12. In addition, the speaker 11, in a case in which connection of the speaker 12 is released, reproduces the audio signal of the L channel and the R channel, in the own apparatus to be paired on the reproduction role.

### (Modification 7)

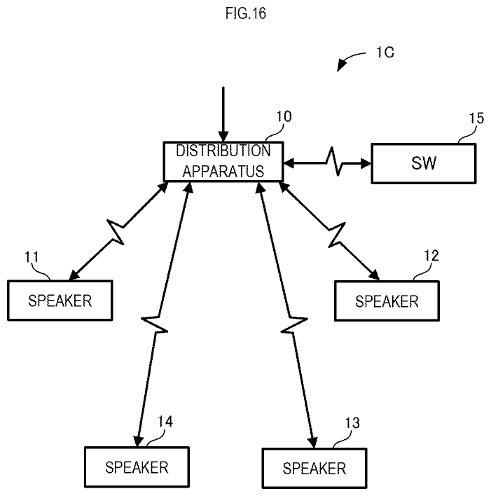

The audio signal distribution system may include a subwoofer. FIG. 16 is a block diagram showing a configuration of an audio signal distribution system 1C including a subwoofer 15. The subwoofer 15 is connected to the distribution apparatus 10. The subwoofer 15 has the same configuration and function as the speakers 11 to 14.

The distribution apparatus 10 distributes an audio signal of an LFE (Low Frequency Effect) channel to the subwoofer 15. The distribution apparatus 10, in a case in which connection of the subwoofer 15 is released, causes any of the speakers 11 to 14 to reproduce the LFE channel. For example, the distribution apparatus 10 distributes the audio signal of the L channel and the LFE channel to the speaker 11 to reproduce the audio signal of the L channel and the LFE channel. Alternatively, as shown in FIG. 13, in a case in which the distribution apparatus is a speaker similar to the sound bar 10A, the distribution apparatus may further reproduce the audio signal of the LFE channel.

### (Modification 8)

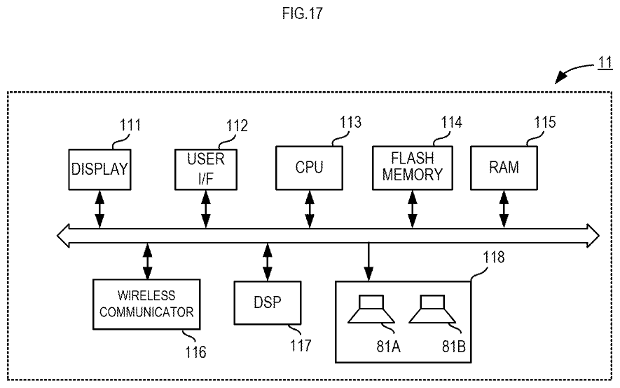

FIG. 17 is a block diagram showing a configuration of a speaker 11 according to Modification 8. The speaker 11 of Modification 8 includes a plurality of speaker units (two speaker units of a speaker unit 81A and a speaker unit 81B in this example).

The speaker 11 receives the audio signal of the plurality of channels, and assigns a channel to each of the plurality of speaker units. For example, the CPU 113, in a case of receiving the audio signal of the L channel and the R channel, causes the speaker unit 81A to reproduce the audio signal of the L channel and causes the speaker unit 81B to reproduce the audio signal of the R channel. In addition, the CPU 113, in a case of receiving only the audio signal of the L channel, for example, may cause the speaker unit 81A and the speaker unit 81B to reproduce the audio signal of the same L channel.

Moreover, the CPU 113 may receive information that shows the reproduction role and may assign the reproduction role to each of the speaker unit 81A and the speaker unit 81B, based on the information. For example, the CPU 113 receives the audio signal of the L channel and the R channel, and, in a case in which the reproduction role assigned to the own apparatus is the L channel, causes the speaker unit 81A and the speaker unit 81B to reproduce the audio signal of the same L channel. The CPU 113 receives the audio signal of the L channel and the R channel, and, in a case in which the reproduction role assigned to the own apparatus is not only the L channel but also the R channel, causes the speaker unit 81A to reproduce the audio signal of the L channel and causes the speaker unit 81B to reproduce the audio signal of the R channel.

Finally, the descriptions of the present embodiments are illustrative in all points and should not be construed to limit the present disclosure. The scope of the present disclosure is defined not by the foregoing embodiments but by the following claims. Further, the scope of the present disclosure is intended to include all modifications within the scopes of the claims and within the meanings and scopes of equivalents.

What is claimed is:

1. An audio signal distribution method comprising:
assigning a reproduction role to each of a plurality of speakers;
distributing an audio signal to the plurality of speakers, according to the assigned reproduction role; and
in response to a number of speakers being decreased, causing a speaker paired with a released speaker on the reproduction role to further reproduce sound of the released speaker.

2. The audio signal distribution method according to claim 1, wherein:
the reproduction role includes a stereo L channel and a stereo R channel; and
in response to the number of speakers being decreased, distributing the audio signal of the L channel and the R channel to the speaker paired with the released speaker on the reproduction role.

3. The audio signal distribution method according to claim 1, wherein:
the reproduction role includes a front channel and a surround channel; and
in response to the number of speakers being decreased, distributing the audio signal of the front channel and the surround channel to the speaker paired with the released speaker on the reproduction role.

4. The audio signal distribution method according to claim 1, wherein, in response to the number of speakers being decreased, increasing a volume of the speaker paired with the released speaker on the reproduction role.

5. The audio signal distribution method according to claim 1, wherein:
the plurality of speakers are connected through a network; the method comprising:
detecting an increase or decrease in the number of speakers based on a connection status of the network.

6. The audio signal distribution method according to claim 1, comprising:
detecting an increase or decrease in the number of speakers by detecting sound reproduced from the plurality of speakers by a microphone.

7. The audio signal distribution method according to claim 6, comprising:
Detecting the increase or decrease in the number of speakers by reproducing non-audible sound from the plurality of speakers and detecting the non-audible sound by the microphone.

8. The audio signal distribution method according to claim 1, wherein:
the reproduction role includes a stereo L channel and a stereo R channel;
the method comprising:
distributing the audio signal of either one of the L channel or the R channel to each of paired speakers on the reproduction role; and
in response to the number of paired speakers being decreased, the audio signal of the L channel and the R channel is distributed to the speaker paired with the released speaker on the reproduction role.

9. The audio signal distribution method according to claim 1, wherein:
the reproduction role includes a stereo L channel and a stereo R channel;
the method comprising:
distributing the audio signal of both of the L channel and the R channel to each of paired speakers on the reproduction role; and
in response to the number of paired speakers being decreased, the speaker paired with the released speaker on the reproduction role reproduces the audio signal of both of the L channel and the R channel.

10. The audio signal distribution method according to claim 1, wherein:
the plurality of speakers each include a plurality of speaker units;
the method comprising:
assigning, by the plurality of speakers, a channel to be reproduced to the plurality of speaker units based on each received audio signal.

11. An audio signal distribution apparatus comprising
a processor configured to:
assign a reproduction role to each of a plurality of speakers;
distribute an audio signal to the plurality of speakers according to the reproduction role; and
in response to a number of speakers being decreased, cause a speaker paired with a released speaker on the reproduction role to further reproduce sound of the released speaker.

12. The audio signal distribution apparatus according to claim 11, wherein:
the reproduction role includes a stereo L channel and a stereo R channel; and
wherein the processor is configured to:
in response to the number of speakers being decreased, distribute the audio signal of the L channel and the R channel to the speaker paired with the released speaker on the reproduction role.

13. The audio signal distribution apparatus according to claim 11, wherein:
the reproduction role includes a front channel and a surround channel; and
wherein the processor is configured to:
in response to the number of speakers being decreased, distribute the audio signal of the front channel and the surround channel to the speaker paired with the released speaker on the reproduction role.

14. The audio signal distribution apparatus according to claim 11, wherein the processor is configured to:
in response to the number of speakers being decreased, increase a volume of the speaker paired with the released speaker on the reproduction role.

15. The audio signal distribution apparatus according to claim 11, wherein:
the plurality of speakers are connected through a network; and
wherein the processor is configured to”
detect an increase or decrease in the number of speakers based on a connection status of the network.

16. The audio signal distribution apparatus according to claim 11, wherein the processor is configured to:
detect an increase or decrease in the number of speakers by detecting sound reproduced from the plurality of speakers using a microphone.

17. The audio signal distribution apparatus according to claim 16, wherein the processor is configured to:
detect the increase or decrease in the number of speakers by reproducing non-audible sound from the plurality of speakers and detecting the non-audible sound by the microphone.

18. The audio signal distribution apparatus according to claim 11, wherein:
the reproduction role includes a stereo L channel and a stereo R channel; and
wherein the processor is configured to:
distribute the audio signal of either one of the L channel or the R channel to each of paired speakers on the reproduction role; and
in response to the number of paired speakers being decreased, distributing the audio signal of the L channel and the R channel to the speaker paired with the released speaker on the reproduction role.

19. The audio signal distribution apparatus according to claim 11, wherein:
the reproduction role includes a stereo L channel and a stereo R channel; and
wherein the processor is configured to:
distribute the audio signal of both of the L channel and the R channel to each of paired speakers on the reproduction role; and
in response to the number of paired speakers being decreased, cause the speaker paired with the released speaker on the reproduction role to reproduce the audio signal of both of the L channel and the R channel.

20. An audio signal distribution system comprising:
a plurality of speakers; and
an audio signal distribution apparatus, wherein:
the audio signal distribution apparatus is configured to:
assign a reproduction role to each of the plurality of speakers; and
distribute an audio signal to the plurality of speakers according to the reproduction role;
wherein the plurality of speakers reproduce a distributed audio signal; and
wherein the the audio signal distribution apparatus is further configured to:
in response to a number of speakers being decreased, cause a speaker paired with a released speaker on the reproduction role to further reproduce sound of the released speaker.
